(19) United States
(12) Patent Application Publication
(10) Pub. No.: US 2016/0087814 A1
(43) Pub. Date: Mar. 24, 2016

(54) WIRELESS-COMMUNICATION QUALITY-INFORMATION PROCESSING DEVICE AND COMMUNICATION SYSTEM

(71) Applicant: MITSUBISHI ELECTRIC CORPORATION, Tokyo (JP)

(72) Inventor: Kunio SHIMIZU, Nagoya-shi (JP)

(73) Assignee: Mitsubishi Electric Corporation, Tokyo (JP)

(21) Appl. No.: 14/888,719

(22) PCT Filed: Mar. 27, 2014
(86) PCT No.: PCT/JP2014/058901

§ 371 Date: Nov. 3, 2015

(51) Int. Cl. H04L 12/66; H04L 12/26; H04L 12/403; H04W 24/08; H04W 24/10

(52) U.S. Cl. CPC H04L 12/66; H04W 24/08; H04W 24/10; H04L 12/403; H04L 43/04; H04W 88/16

(57) ABSTRACT

A PLC network and a wireless network are asynchronous to each other, and data communication between the PLC network and the wireless network is performed via a gateway station. A wireless-communication quality-information processing device includes a reception unit, a wireless-communication quality-information generation unit, and a communication processing unit. The reception unit receives a wireless communication frame transmitted from a wireless slave station of the wireless network. The wireless-communication quality-information generation unit generates wireless-communication quality information indicating quality of wireless communication in the wireless network from characteristic information included in the received wireless communication frame. The communication processing unit determines whether to reflect data included in the wireless communication frame to the PLC network as new data by referring to the wireless-communication quality information.

### FIELD

The present invention relates to a wireless-communication quality-information processing device and a communication system including a wireless-communication quality-information processing device.

### BACKGROUND

A PLC (Programmable Logic Controller) is a controller that is used for controlling industrial apparatuses in a factory or the like. By connecting PLCs via a network such that they can communicate with one another, a PLC network capable of performing large-scale control is established. In a PLC network, due to the characteristics thereof, high reliability is required, and it is necessary to perform cyclic and high-speed data communication. That is, the characteristics of a PLC network include high regularity, a high transmission rate, and a low error rate.

Meanwhile, from the viewpoint of its ease of establishment, wireless networks for controlling industrial apparatuses have come into widespread use in recent years. In such wireless networks, the communication quality may deteriorate and route changes may be caused. Therefore, there can be problems such as a data communication delay due to the variations in response time and a failure in performing data communication due to the occurrence of data errors. That is, the characteristics of a wireless network include low regularity, a low transmission rate, and a high error rate. Thus, it can be said that, it is difficult to ensure the reliability of a wireless network.

Patent Literature 1 discloses a technique for improving the reliability of data communication in a wireless LAN system. Specifically, when a failure occurs at an access point with which a wireless terminal is associated, the wireless terminal immediately performs data communication with an access point that has been registered in advance as a backup access point.

### CITATION LIST

### Patent Literature

Patent Literature 1: Japanese Patent Application Laid-open No. 2004-179909

### SUMMARY

### Technical Problem

There has been a demand for data communication between a PLC network and a wireless network. However, a PLC network and a wireless network are asynchronous to each other, and, as described above, there are differences in regularity, transmission rate, and error rate. Therefore, there is a problem in that data from a wireless network is difficult use in a PLC network, which requires high reliability.

For example, considered here is a case where both a PLC network and a wireless network perform cyclic communication. When cyclic data of the wireless network, the reliability of which is difficult to ensure, is transmitted to the PLC network, which requires reliability, the cyclic data may not be the latest data and it is also not possible to determine whether the cyclic data is the latest data. Therefore, there is a problem in that cyclic data of a wireless network is difficult to use in a PLC network.

An object of the present invention is to provide a technique that allows practical use of data from a wireless network in a PLC network.

### Solution to Problem

According to an aspect of the present invention, a wireless-communication quality-information processing device in a communication system is provided. The communication system includes a PLC network having a PLC connected thereto, a wireless network having a wireless slave station connected thereto, and a gateway station that connects the PLC network and the wireless network to each other. The PLC network and the wireless network are asynchronous to each other, and data communication between the PLC network and the wireless network is performed via the gateway station. The wireless-communication quality-information processing device includes: a reception unit; a wireless-communication quality-information generation unit; and a communication processing unit. The reception unit receives a wireless communication frame transmitted from the wireless slave station. The wireless-communication quality-information generation unit generates wireless-communication quality information indicating quality of wireless communication in the wireless network from characteristic information included in the received wireless communication frame. The communication processing unit determines, by referring to the wireless-communication quality information, whether to reflect data included in the wireless communication frame to the PLC network as new data.

According to another aspect of the present invention, a communication system is provided. The communication system includes a PLC network having a PLC connected thereto, a wireless network having a wireless slave station connected thereto, a gateway station that connects the PLC network and the wireless network to each other, and a wireless-communication quality-information processing device. The PLC network and the wireless network are asynchronous to each other, and data communication between the PLC network and the wireless network is performed via the gateway station. The wireless-communication quality-information processing device includes: a reception unit; a wireless-communication quality-information generation unit; and a communication processing unit. The reception unit receives a wireless communication frame transmitted from the wireless slave station. The wireless-communication quality-information generation unit generates wireless-communication quality information indicating quality of wireless communication in the wireless network from characteristic information included in the received wireless communication frame. The communication processing unit determines, by referring to the wireless-communication quality information, whether to reflect data included in the wireless communication frame to the PLC network as new data.

### Advantageous Effects of Invention

According to the present invention, practical use of data from a wireless network in a PLC network can be made.

### BRIEF DESCRIPTION OF DRAWINGS

FIG. 1 is a block diagram schematically illustrating a configuration example of a communication system according to a first embodiment of the present invention.

FIG. 2 is a conceptual diagram illustrating a configuration example of a wireless communication frame according to the first embodiment of the present invention.

FIG. 3 is a block diagram illustrating a configuration example of the wireless-communication quality-information processing device according to the first embodiment of the present invention.

FIG. 4 is a flowchart illustrating a process performed by the wireless-communication quality-information processing device according to the first embodiment of the present invention.

FIG. 5 is a conceptual diagram illustrating an example of wireless-communication quality information according to the first embodiment of the present invention.

FIG. 6 is a conceptual diagram illustrating a configuration example of a PLC communication frame according to the first embodiment of the present invention.

FIG. 7 is a block diagram schematically illustrating an operation of the communication system according to the first embodiment of the present invention.

FIG. 8 is a block diagram schematically illustrating an operation of a communication system according to a second embodiment of the present invention.

FIG. 9 is a block diagram illustrating a configuration example of a wireless-communication quality-information processing device according to a third embodiment of the present invention.

FIG. 10 is a block diagram schematically illustrating an operation of a communication system according to the third embodiment of the present invention.

FIG. 11 is a block diagram schematically illustrating an operation of a communication system according to a fourth embodiment of the present invention.

FIG. 12 is a block diagram illustrating a configuration example of a wireless-communication quality-information processing device according to a fifth embodiment of the present invention.

### DESCRIPTION OF EMBODIMENTS

Exemplary embodiments of the present invention will be explained with reference to the accompanying drawings.

### First Embodiment

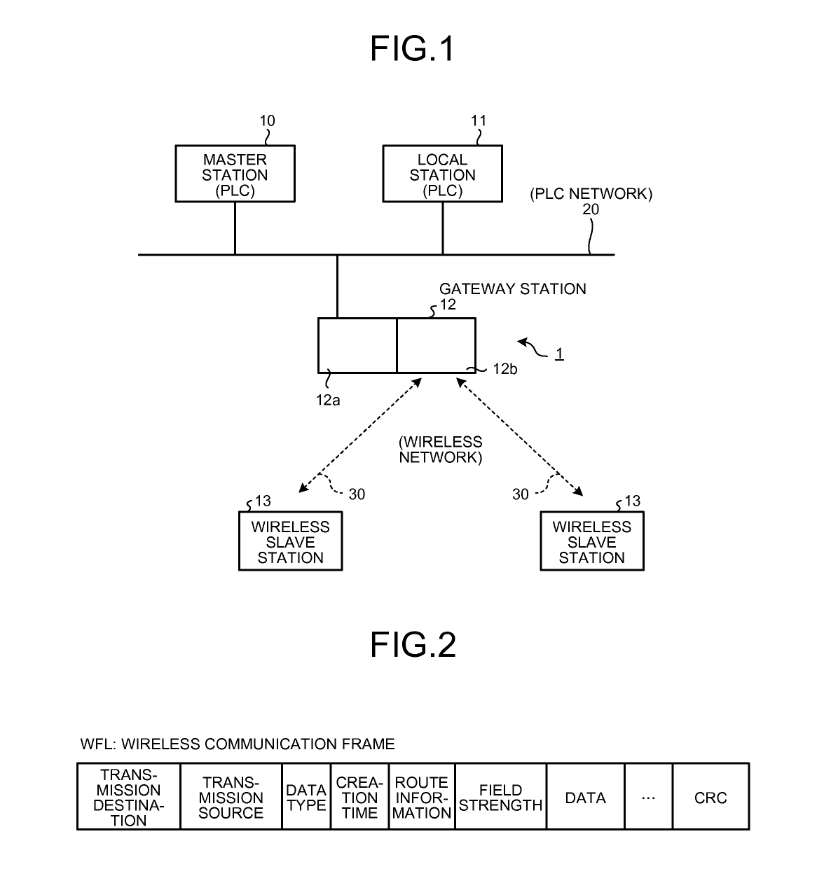

FIG. 1 is a block diagram schematically illustrating a configuration example of a communication system 1 according to a first embodiment of the present invention. The communication system 1 includes a PLC network 20, a wireless network 30, and a gateway station 12.

The PLC network 20 is configured by connecting a plurality of PLCs to one another such that they can communicate with one another. The PLC network 20 is, for example, configured by a wired LAN, but the configuration thereof is not limited to that of a wired LAN. In the example illustrated in FIG. 1, a master station 10 and a local station 11 are illustrated as PLCs. The master station 10 manages respective stations connected to the PLC network 20. The respective stations include the local station 11. In the PLC network 20, due to the characteristics thereof, high reliability is required and cyclic and high-speed data communication needs to be performed. That is, the characteristics of the PLC network 20 include high regularity, a high transmission rate, and a low error rate.

The wireless network 30 is configured by connecting a plurality of wireless slave stations 13 to one another. The wireless network 30 is, for example, formed by a wireless LAN, but the configuration thereof is not limited to that of a wireless LAN. In the wireless network 30, there may be incidents such as the communication quality becoming deteriorated or route changes being caused. Therefore, there are problems such as a data communication delay due to the variations in response time and a failure in performing data communication due to the occurrence of data errors. That is, the characteristics of the wireless network 30 include low regularity, a low transmission rate, and a high error rate.

The PLC network 20 and the wireless network 30 are asynchronous to each other, and, as described above, there are differences in regularity, transmission rate, and error rate. The PLC network 20 and the wireless network 30 are connected by the gateway station 12. That is, data communication between the PLC network 20 and the wireless network 30 is performed via the gateway station 12.

The gateway station 12 includes a PLC-network communication unit 12a and a wireless-network communication unit 12b. The PLC-network communication unit 12a is connected to the PLC network 20 to communicate with the PLC network 20. The wireless-network communication unit 12b functions as a master station of the wireless network 30 and manages stations connected to the wireless network 30.

Both the PLC network 20 and the wireless network 30 perform cyclic communication.

Each of the master station 10, the local station 11, and the PLC-network communication unit 12a of the gateway station 12 includes a memory (for example, a RAM) to be used for cyclic-data communication with stations connected to the PLC network 20. Similarly, each of the wireless-network communication unit 12b of the gateway station 12 and the wireless slave stations 13 includes a memory to be used for cyclic-data communication with stations connected to the wireless network 30. Cyclic data of the PLC network 20 and cyclic data of the wireless network 30 are transmitted and received via shared memories of the PLC-network communication unit 12a and the wireless-network communication unit 12b of the gateway station 12. The memories are used not only for cyclic-data communication that is performed periodically but also for data communication that is performed aperiodically.

FIG. 2 is a conceptual diagram illustrating a configuration example of a wireless communication frame WFL that is transmitted from the wireless slave station 13 in the wireless network 30. The wireless communication frame

WFL includes header information, characteristic information, and a data body. The header information includes the transmission destination and the transmission source of data and the data type. The characteristic information includes the data creation time at the wireless slave station 13 that is the transmission source and a CRC (Cyclic Redundancy Check) code, which is an example of an error detecting code. The characteristic information can further include route information (topology information) on the wireless network 30 and a received field strength measured at the wireless slave station 13.

For example, cyclic communication of the wireless communication frame WFL as illustrated in FIG. 2 is performed in the wireless network 30. That is, the wireless slave stations 13 periodically transmit the wireless communication frame WFL as cyclic data. The wireless-network communication unit 12b of the gateway station 12 functioning as a master station of the wireless network 30 can receive the wireless communication frame WFL from the wireless slave stations 13 and can obtain the characteristic information described above from the received wireless communication frame WFL.

A technique for obtaining and utilizing “wireless-communication quality information” in the communication system 1 described above is explained. The wireless-communication quality information indicates the quality of wireless communication in the wireless network 30. Such wireless-communication quality information is obtained and utilized by a “wireless-communication quality-information processing device 100”. Typically, the wireless-communication quality-information processing device 100 is incorporated in the gateway station 12. Alternatively, as described in the following embodiments, the wireless-communication quality-information processing device 100 can be incorporated in the PLCs (10, 11).

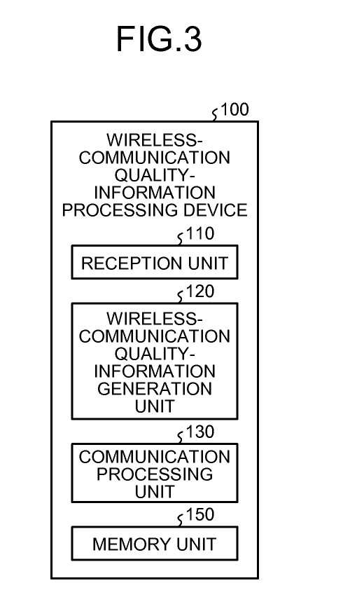

FIG. 3 is a block diagram illustrating a configuration example of the wireless-communication quality-information processing device 100 according to the present embodiment. The wireless-communication quality-information processing device 100 includes a reception unit 110, a wireless-communication quality-information generation unit 120, a communication processing unit 130, and a memory unit 150. The reception unit 110 is constituted by a communication interface. The wireless-communication quality-information generation unit 120 and the communication processing unit 130 are realized by a processor executing a control program. The control program can be recorded in a computer-readable recording medium.

The memory unit 150 is a memory device that stores therein various kinds of data to be used for communication processing.

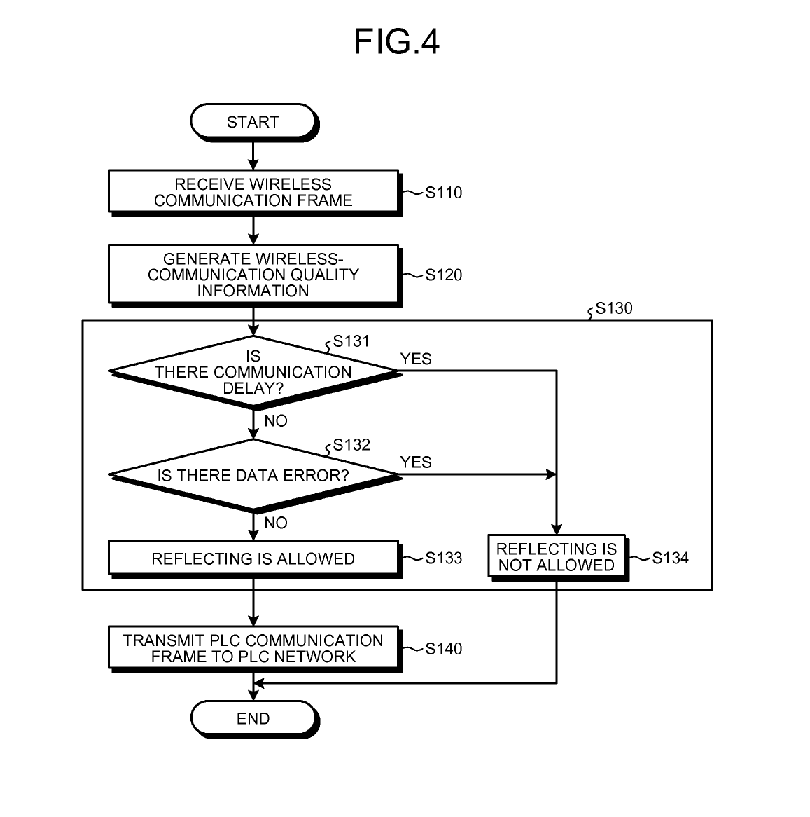

A process flow performed by the wireless-communication quality-information processing device 100 illustrated in FIG. 3 is described with reference to FIG. 4.

Step S110:

The reception unit 110 receives the wireless communication frame WFL transmitted from the wireless slave station 13.

Step S120:

The wireless-communication quality-information generation unit 120 obtains characteristic information included in the received wireless communication frame WFL. The wireless-communication quality-information generation unit 120 then generates wireless-communication quality information CQ from the obtained characteristic information. FIG. 5 illustrates an example of the wireless-communication quality information CQ.

The wireless-communication quality information CQ includes the presence or absence of a communication delay. The wireless-communication quality-information generation unit 120 can determine whether there is a communication delay on the basis of the current time and the data creation time included in the received wireless communication frame WFL. For example, when a difference between the current time and the data creation time is equal to or more than one second, it is determined that there is a communication delay. Similarly, the wireless-communication quality-information generation unit 120 can also calculate the average response time at the wireless slave station 13.

The wireless-communication quality information CQ includes the presence or absence of a data error. The wireless-communication quality-information generation unit 120 performs a CRC check by using a CRC code included in the received wireless communication frame WFL, thereby determining whether there is a data error.

The wireless-communication quality information CQ can further include route information (topology information) on the wireless network 30 and a received field strength measured at the wireless slave station 13. The wireless-communication quality-information generation unit 120 can use the route information and the received field strength included in the received wireless communication frame WFL as they are.

Step S130:

The communication processing unit 130 determines whether to reflect the data included in the received wireless communication frame WFL to the PLC network 20 as “new data” by referring to the wireless-communication quality information CQ that has been generated at Step S120. At this point, the communication processing unit 130 determines whether the wireless-communication quality indicated by the wireless-communication quality information CQ satisfies a constant level.

For example, when there is no communication delay and there is no data error (NO at Step S131 and NO at Step S132), the communication processing unit 130 determines that the data included in the received wireless communication frame WFL can be reflected to the PLC network 20 as new data (Step S133). Thereafter, the process advances to Step S140.

In contrast, when there is a communication delay (YES at Step S131) or when there is a data error (YES at Step 132), the communication processing unit 130 determines not to reflect the data included in the received wireless communication frame WFL to the PLC network 20 as new data (Step S134). Thereafter, the process ends.

However, the details of Step S130 illustrated in FIG. 4 are only examples, and the details of Step S130 can be designed as appropriate. For example, it is also possible that, when there is no communication delay (NO at Step S131) or when there is no data error (NO at Step S132), the process advances to Step S133, and when both a communication delay and a data error exist (YES at Step S131 and YES at Step S132), the process advances to Step S134.

Step S140:

The communication processing unit 130 transmits a PLC communication frame PFL that corresponds to the received wireless communication frame WFL to the PLC network 20.

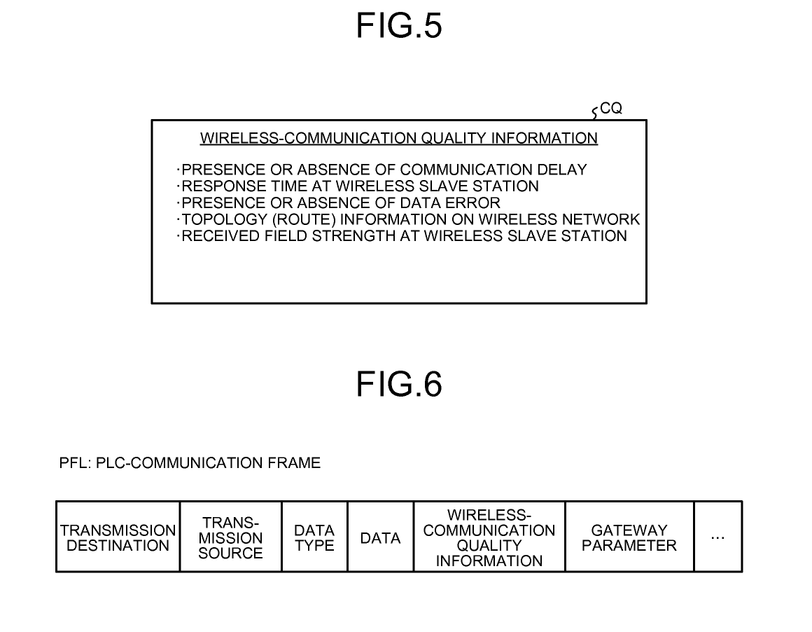

FIG. 6 is a conceptual diagram illustrating a configuration example of the PLC communication frame PFL.

In the example illustrated in FIG. 6, the PLC communication frame PFL includes header information, a data body, and the wireless-communication quality information CQ. The header information includes the transmission destination and the transmission source of data and the data type. The data body is the same as that included in the received wireless communication frame WFL. The wireless-communication quality information CQ is information generated at Step S120 described above.

The PLC communication frame PFL can further include a gateway parameter. The gateway parameter is a parameter that is set for the gateway station 12 and includes a communication cycle in the wireless network 30 and a threshold to be used for the determination of the presence or absence of a communication delay described above.

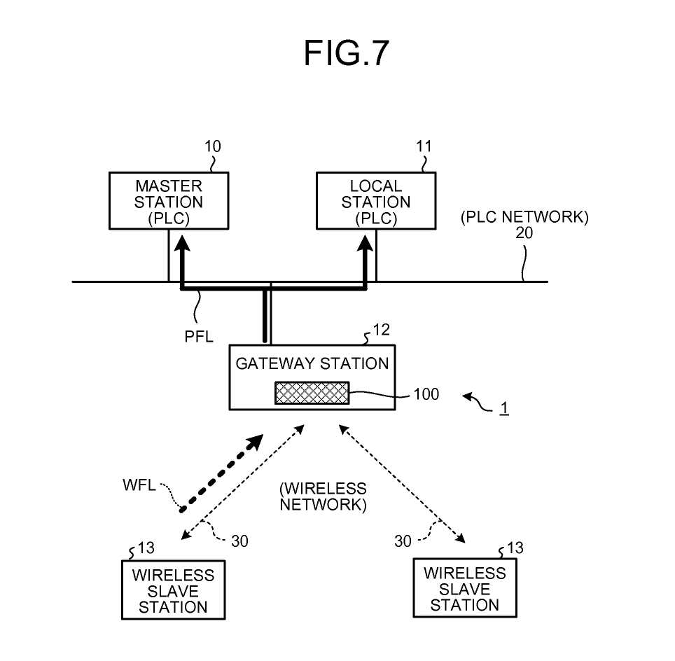

FIG. 7 schematically illustrates an operation of the communication system 1 when the gateway station 12 includes the wireless-communication quality-information processing device 100. The wireless slave stations 13 of the wireless network 30 transmit the wireless communication frame WFL by cyclic communication. The gateway station 12 including the wireless-communication quality-information processing device 100 receives the wireless communication frame WFL and performs the process illustrated in FIG. 4. When reflecting is allowed (Step S133), the gateway station 12 transmits the PLC communication frame PFL to the PLC network 20 by cyclic communication.

The present embodiment is not limited to cyclic-data communication that is performed periodically, but is also applicable to data communication that is performed aperiodically.

As described above, according to the present embodiment, the wireless-communication quality-information processing device 100 automatically generates the wireless-communication quality information CQ from information included in the received wireless communication frame WFL. Further, the wireless-communication quality-information processing device 100 automatically determines whether to reflect received data to the PLC network 20 as new data by referring to the wireless-communication quality information CQ. With this configuration, in the PLC network 20 that requires high reliability, data from the wireless network 30 can be practically used.

The function of the wireless-communication quality-information processing device 100 can be variably set. For example, whether the generation process of the wireless-communication quality information CQ (Step S120) is performed can be specified. In this case, the wireless-communication quality-information processing device 100 retains a function specifying parameter for specifying whether Step S120 is performed, i.e., for specifying enabling or disabling of the function of the wireless-communication quality-information generation unit 120. The function specifying parameter is, for example, stored in the memory unit 150 illustrated in FIG. 3. When the function specifying parameter specifies “enable”, the wireless-communication quality-information generation unit 120 functions and performs Step S120.

Similarly, whether Step S130 and Step S140, which are performed by the communication processing unit 130, are performed can be specified. In this case, the wireless-communication quality-information processing device 100 retains a function specifying parameter for specifying whether Steps S130 and S140 are performed, i.e., for specifying enabling or disabling of the function of the communication processing unit 130. When the function specifying parameter specifies “enable”, the communication processing unit 130 functions and performs Steps S130 and S140.

### Second Embodiment

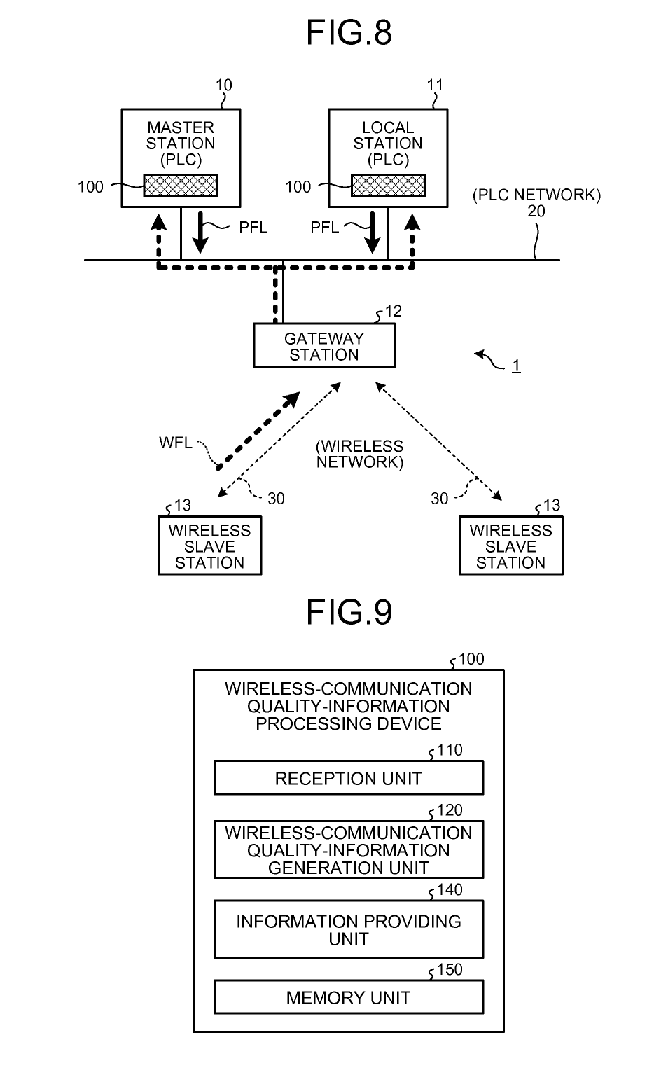

FIG. 8 schematically illustrates an operation of the communication system 1 when the PLC (the master station 10 or the local station 11) of the PLC network 20 includes the wireless-communication quality-information processing device 100. Descriptions overlapping with those of the first embodiment are omitted as appropriate.

The wireless slave stations 13 of the wireless network 30 transmit the wireless communication frame WFL by cyclic communication. When the gateway station 12 receives the wireless communication frame WFL, the gateway station 12 transfers the details of the wireless communication frame WFL to a PLC including the wireless-communication quality-information processing device 100. At this point, the gateway station 12 also notifies the PLC of the gateway parameter.

The PLC including the wireless-communication quality-information processing device 100 receives the wireless communication frame WFL and performs the process illustrated in FIG. 4. When reflecting is allowed (Step S133), the PLC transmits the PLC communication frame PFL to the PLC network 20 by cyclic communication.

The present embodiment is not limited to cyclic-data communication that is performed periodically, but is also applicable to data communication that is performed aperiodically.

Effects identical to those of the first embodiment can be also achieved by the present embodiment.

### Third Embodiment

FIG. 9 is a block diagram illustrating a configuration example of the wireless-communication quality-information processing device 100 according to a third embodiment of the present invention. Descriptions overlapping with those of the first embodiment are omitted as appropriate.

The wireless-communication quality-information processing device 100 according to the present embodiment includes an information providing unit 140 instead of the communication processing unit 130. The information providing unit 140 provides the wireless-communication quality information CQ to a user terminal that is connected to the wireless-communication quality-information processing device 100. The information providing unit 140 can further provide the gateway parameter to the user terminal.

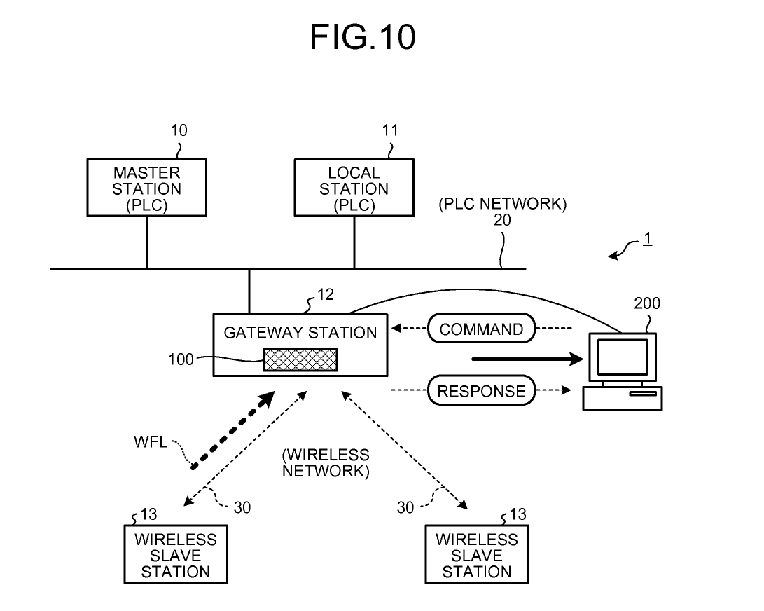

FIG. 10 schematically illustrates an operation of the communication system 1 when the gateway station 12 includes the wireless-communication quality-information processing device 100. An engineering terminal 200 is connected to the gateway station 12 including the wireless-communication quality-information processing device 100. The engineering terminal 200 is mainly used for setting the wireless slave stations 13 or for obtaining the wireless-communication quality information CQ.

Generation of the wireless-communication quality information CQ is the same as that in the first embodiment described above. The engineering terminal 200 issues an information request command to the gateway station 12 including the wireless-communication quality-information processing device 100. In response to the information request command, the information providing unit 140 of the gateway station 12 returns the wireless-communication quality information CQ and the gateway parameter to the engineering terminal 200.

In this manner, a user can obtain the wireless-communication quality information CQ and the gateway parameter by using the engineering terminal 200. The user can know the operation state of the wireless network 30 on the basis of the obtained information, thereby improving the maintainability. For example, the user can diagnose the wireless slave stations 13, can isolate a failure location, or can change designs.

The function of the wireless-communication quality-information processing device 100 can be variably set. For example, whether the generation process of the wireless-communication quality information CQ (Step S120) is performed can be specified. In this case, the wireless-communication quality-information processing device 100 retains a function specifying parameter for specifying whether Step S120 is performed, i.e., for specifying enabling or disabling of the function of the wireless-communication quality-information generation unit 120. The function specifying parameter is, for example, stored in the memory unit 150 illustrated in FIG. 9. When the function specifying parameter specifies “enable”, the wireless-communication quality-information generation unit 120 functions and performs Step S120.

Similarly, whether an information providing process performed by the information providing unit 140 is performed can be specified. In this case, the wireless-communication quality-information processing device 100 retains a function specifying parameter for specifying whether the information providing process is performed, i.e., for specifying enabling or disabling of the function of the information providing unit 140. When the function specifying parameter specifies “enable”, the information providing unit 140 functions and performs the information providing process.

### Fourth Embodiment

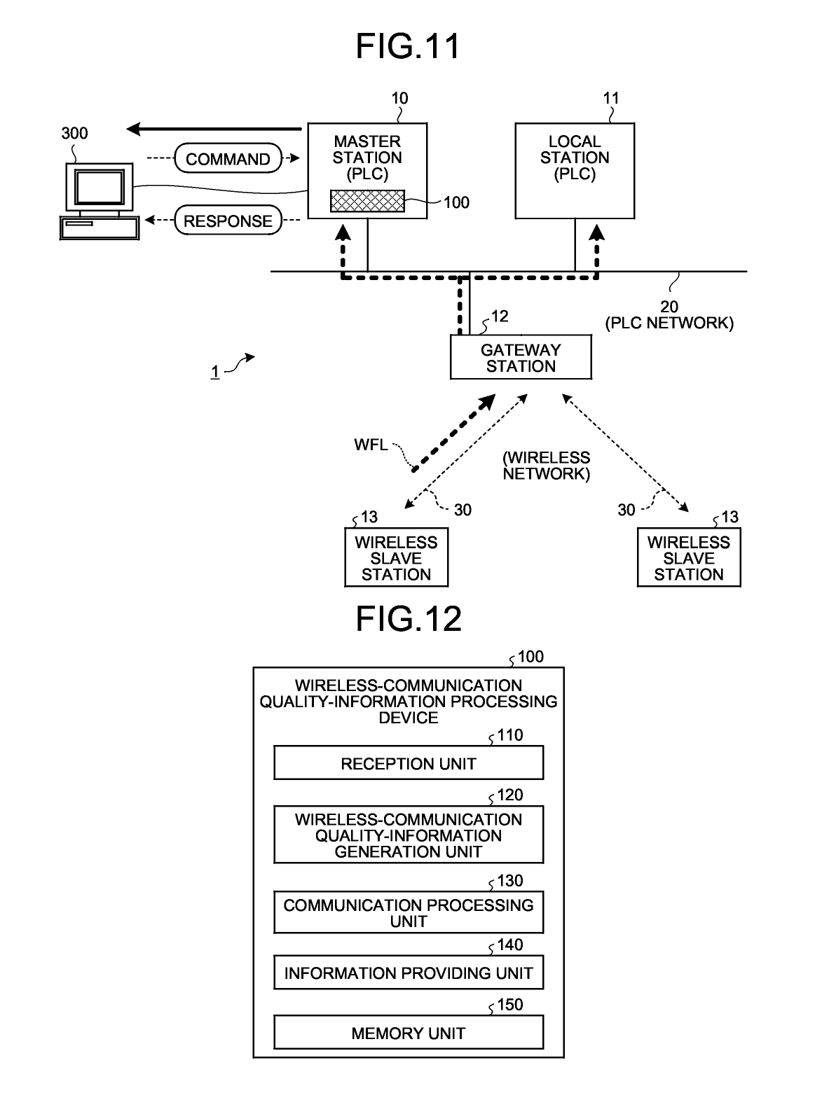

FIG. 11 illustrates a case where the wireless-communication quality-information processing device 100 illustrated in FIG. 9 is incorporated in the PLC (the master station 10 or the local station 11) of the PLC network 20. Descriptions overlapping with those of the above embodiments are omitted as appropriate.

An engineering terminal 300 is connected to a PLC including the wireless-communication quality-information processing device 100. Generation of the wireless-communication quality information CQ is the same as that in the second embodiment described above. The engineering terminal 300 issues an information request command to the PLC. In response to the information request command, the information providing unit 140 of the PLC returns the wireless-communication quality information CQ and the gateway parameter to the engineering terminal 300.

Effects identical to those of the third embodiment can be also achieved by the present embodiment.

### Fifth Embodiment

FIG. 12 is a block diagram illustrating a configuration example of the wireless-communication quality-information processing device 100 according to a fifth embodiment of the present invention. The wireless-communication quality-information processing device 100 according to the present embodiment includes both the communication processing unit 130 and the information providing unit 140. Such a configuration is applicable to all the above embodiments.

Embodiments of the present invention have been described above with reference to the accompanying drawings. Note that the present invention is not limited to the embodiments described above and can be modified as appropriate by persons skilled in the art without departing from the scope thereof.

### REFERENCE SIGNS LIST

1 communication system, 10 master station (PLC), local station (PLC), 12 gateway station, 12a PLC-network communication unit, 12b wireless-network communication unit, 13 wireless slave station, 20 PLC network, 30 wireless network, 100 wireless-communication quality-information processing device, 110 reception unit, 120 wireless-communication quality-information generation unit, 130 communication processing unit, 140 information providing unit, 150 memory unit, 200 engineering terminal, 300 engineering terminal, CQ wireless-communication quality information, PFL PLC communication frame, WFL wireless communication frame.

1. A wireless-communication quality-information processing device in a communication system, wherein
the communication system includes
a PLC network having a PLC connected thereto,
a wireless network having a wireless slave station connected thereto, and
a gateway station that connects the PLC network and the wireless network to each other,
the PLC network and the wireless network are asynchronous to each other, and data communication between the PLC network and the wireless network is performed via the gateway station,
the wireless-communication quality-information processing device comprises:
a reception unit that receives a wireless communication frame transmitted from the wireless slave station;
a wireless-communication quality-information generation unit that generates wireless-communication quality information indicating quality of wireless communication in the wireless network from characteristic information included in the received wireless communication frame; and
a communication processing unit that determines, by referring to the wireless-communication quality information, whether to reflect data included in the wireless communication frame to the PLC network as new data,
when the quality indicated by the wireless-communication quality information satisfies a constant level, the communication processing unit determines to reflect the data included in the wireless communication frame to the PLC network and transmits a PLC communication frame including the data to the PLC network,
the characteristic information in the wireless communication frame includes a data creation time and an error detecting code,
the wireless-communication quality-information generation unit determines whether there is a communication delay on a basis of the data creation time and a current time, and determines whether there is a data error on a basis of the error detecting code, and
the wireless-communication quality information includes presence or absence of the communication delay and presence or absence of the data error.

2. (canceled)

3. The wireless-communication quality-information processing device according to claim 1, wherein when at least one of the communication delay and the data error does not exist, the communication processing unit determines to reflect the data included in the wireless communication frame to the PLC network as the new data.

4. The wireless-communication quality-information processing device according to claim 1, wherein each of the characteristic information in the wireless communication frame and the wireless-communication quality information further includes topology information on the wireless network and a received field strength at the wireless slave station.

5. The wireless-communication quality-information processing device according to claim 1, wherein the PLC communication frame further includes the wireless-communication quality information.

6. The wireless-communication quality-information processing device according to claim 1, wherein
cyclic communication of the wireless communication frame is performed in the wireless network, and
cyclic communication of the PLC communication frame is performed in the PLC network.

7. The wireless-communication quality-information processing device according to claim 1, further comprising an information providing unit that provides the wireless-communication quality information to a terminal connected to the wireless-communication quality-information processing device.

8. The wireless-communication quality-information processing device according to claim 7, wherein
the information providing unit further provides a gateway parameter to the terminal, and
the gateway parameter is a parameter set for the gateway station and includes a communication cycle in the wireless network and a threshold to be used for determination of the communication delay.

9. The wireless-communication quality-information processing device according to claim 1, wherein the gateway station includes the wireless-communication quality-information processing device.

10. The wireless-communication quality-information processing device according to claim 1, wherein
the PLC includes the wireless-communication quality-information processing device, and
the gateway station transfers the wireless communication frame received from the wireless slave station to the PLC.

11. The wireless-communication quality-information processing device according to claim 1, wherein the wireless-communication quality-information processing device retains a first function specifying parameter for specifying enabling or disabling of the wireless-communication quality-information generation unit.

12. The wireless-communication quality-information processing device according to claim 1, wherein the wireless-communication quality-information processing device retains a second function specifying parameter for specifying enabling or disabling of the communication processing unit.

13. A communication system comprising:
a PLC network having a PLC connected thereto;
a wireless network having a wireless slave station connected thereto;
a gateway station that connects the PLC network and the wireless network to each other; and
a wireless-communication quality-information processing device, wherein
the PLC network and the wireless network are asynchronous to each other, and data communication between the PLC network and the wireless network is performed via the gateway station,
the wireless-communication quality-information processing device includes
a reception unit that receives a wireless communication frame transmitted from the wireless slave station,
a wireless-communication quality-information generation unit that generates wireless-communication quality information indicating quality of wireless communication in the wireless network from characteristic information included in the received wireless communication frame, and
a communication processing unit that determines, by referring to the wireless-communication quality information, whether to reflect data included in the wireless communication frame to the PLC network as new data,
when the quality indicated by the wireless-communication quality information satisfies a constant level, the communication processing unit determines to reflect the data included in the wireless communication frame to the PLC network and transmits a PLC communication frame including the data to the PLC network,
the characteristic information in the wireless communication frame includes a data creation time and an error detecting code,
the wireless-communication quality-information generation unit determines whether there is a communication delay on a basis of the data creation time and a current time, and determines whether there is a data error on a basis of the error detecting code, and
the wireless-communication quality information includes presence or absence of the communication delay and presence or absence of the data error.

14. The communication system according to claim 13, wherein the wireless-communication quality-information processing device retains a first function specifying parameter for specifying enabling or disabling of the wireless-communication quality-information generation unit.

15. The communication system according to claim 13, wherein the wireless-communication quality-information processing device retains a second function specifying parameter for specifying enabling or disabling of the communication processing unit.

16. A wireless-communication quality-information processing device in a communication system, wherein
the communication system includes
a PLC network having a PLC connected thereto,
a wireless network having a wireless slave station connected thereto, and
a gateway station that connects the PLC network and the wireless network to each other,
the PLC network and the wireless network are asynchronous to each other, and data communication between the PLC network and the wireless network is performed via the gateway station,
the wireless-communication quality-information processing device comprises:
a reception unit that receives a wireless communication frame transmitted from the wireless slave station;
a wireless-communication quality-information generation unit that generates wireless-communication quality information indicating quality of wireless communication in the wireless network from characteristic information included in the received wireless communication frame; and
an information providing unit that provides the wireless-communication quality information to a terminal connected to the wireless-communication quality-information processing device,
the characteristic information in the wireless communication frame includes a data creation time and an error detecting code,
the wireless-communication quality-information generation unit determines whether there is a communication delay on a basis of the data creation time and a current time, and determines whether there is a data error on a basis of the error detecting code, and
the wireless-communication quality information includes presence or absence of the communication delay and presence or absence of the data error.

17. (canceled)

18. The wireless-communication quality-information processing device according to claim 16, wherein
the information providing unit further provides a gateway parameter to the terminal, and
the gateway parameter is a parameter set for the gateway station and includes a communication cycle in the wireless network and a threshold to be used for determination of the communication delay.

19. The wireless-communication quality-information processing device according to claim 16, wherein the wireless-communication quality-information processing device retains a first function specifying parameter for specifying enabling or disabling of the wireless-communication quality-information generation unit.

20. The wireless-communication quality-information processing device according to claim 16, wherein the wireless-communication quality-information processing device retains a third function specifying parameter for specifying enabling or disabling of the information providing unit.
